(19) United States
(12) Patent Application Publication
(10) Pub. No.: US 2021/0206056 A1
(43) Pub. Date: Jul. 8, 2021

(54) ADDITIVE MANUFACTURING

(71) Applicant: HEWLETT-PACKARD DEVELOPMENT COMPANY, L.P., Spring, TX (US)

(72) Inventor: Arthur H. BARNES, Vancouver, WA (US)

(73) Assignee: HEWLETT-PACKARD DEVELOPMENT COMPANY, L.P., Houston, TX (US)

(21) Appl. No.: 16/075,483

(22) PCT Filed: Apr. 21, 2017
(86) PCT No.: PCT/US2017/028988

§ 371 Date: Aug. 3, 2018

(51) Int. Cl. B29C 64/165; B29C 64/236; B29C 64/393; B29C 64/277; B29C 64/314; B33Y 10/00; B33Y 30/00; B33Y 40/10; B33Y 50/02

(52) U.S. Cl. CPC B29C 64/165; B29C 64/236; B29C 64/393; B29C 64/277; B33Y 50/02; B33Y 10/00; B33Y 30/00; B33Y 40/10; B29C 64/314

(57) ABSTRACT

Some examples include a fusing apparatus for an additive manufacturing machine. The fusing apparatus includes an enclosure movable in an x-direction across the build zone, the build zone is to contain a build material and a fusing agent. A thermic source is housed in the enclosure, the thermic source is to direct thermic energy toward the build zone and includes a warming source to emit a first emission spectrum and a fusing source to emit a second emission spectrum. A control is to continuously modulate levels of the thermal energy produced by the thermic source during a build cycle.

### BACKGROUND

Additive manufacturing machines produce 3D objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices each defining that part of a layer or layers of build material to be formed into the object.

### BRIEF DESCRIPTION OF THE DRAWINGS

FIG. 1 is a schematic side view of an example fusing apparatus for an additive manufacturing machine in accordance with aspects of the present disclosure.

FIG. 2 is a flow chart of an example method of operating a fusing apparatus of an additive manufacturing machine in accordance with aspects of the present disclosure.

FIG. 3 is a flow chart of another example method of operating a fusing apparatus of an additive manufacturing machine in accordance with aspects of the present disclosure.

FIG. 4 is a schematic side view of an additive manufacturing machine in accordance with aspects of the present disclosure.

FIGS. 5A-8B are side and top schematic views illustrating a sequence of an example four pass fusing cycle using a fusing system of an additive manufacturing machine in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In some additive manufacturing processes, thermic energy is used to fuse together the particles in a powdered build material to form a solid object. Thermic energy to fuse the build material may be generated, for example, by applying a liquid fusing agent to a thin layer of powdered build material in a pattern based on the object slice and then exposing the patterned area to fusing energy. Fusing energy absorbing components in the fusing agent absorb fusing energy to help sinter, melt or otherwise fuse the build material. The process is repeated layer by layer and slice by slice to complete the object.

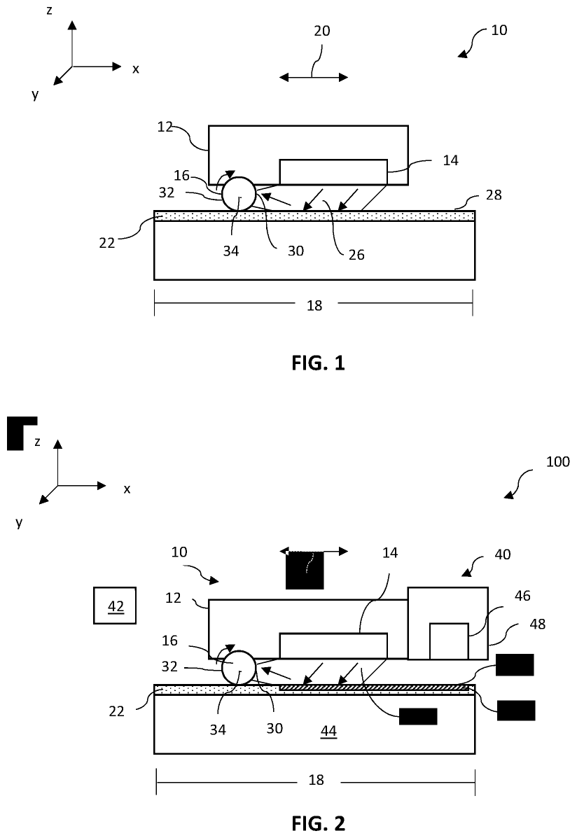

FIG. 1 is a schematic side view of a fusing apparatus 10 for an additive manufacturing machine in accordance with aspects of the present disclosure. Fusing apparatus includes an enclosure 12, a thermic source 14, and a control 16. Enclosure 12 is movable in an x-axial direction across a build zone 18. Build zone 18 can contain a build material 20 and a fusing agent 22. Thermic source 14 is housed in enclosure 12. Thermic source 14 directs thermic energy toward build zone 18. Thermic source 14 includes a warming source, or first thermic source, 24 to emit a first emission spectrum and a fusing source, or second thermic source, 26 to emit a second emission spectrum.

Thermic source 14 remains energized during all cycles of the build process of a three dimensional object. Warming and fusing sources 24, 26 emit different color temperatures (i.e., emission spectrums). Warming source 24 can be adjusted to maintain unfused build material at a target control temperature. Fusing energy from fusing source 26 can vary and can be adjusted on each of pass of the build process. Warming source 24 and fusing source 26 can be independently and separately adjusted to emit independently modulated emission spectrums.

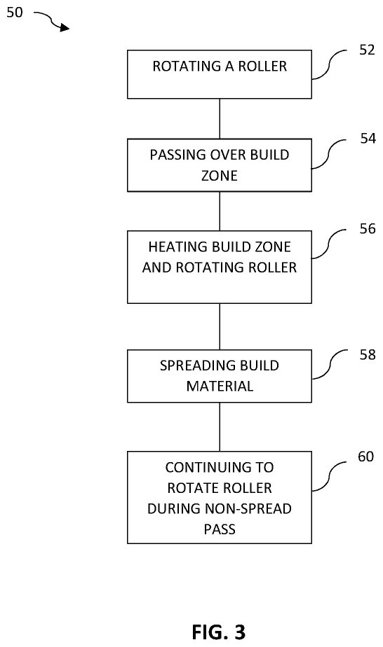

FIG. 2 is a flow chart of an example method 30 of operating a fusing apparatus of an additive manufacturing machine in accordance with aspects of the present disclosure. At 32, a thermal energy is produced with a thermic source. The thermal energy includes a segregated emission spectrum including a first emission spectrum and a second emission spectrum. The first and second emission spectrums each oriented to emit longitudinally along a y-axis. At 34, the thermic source is translated along an x-axis over a build zone. At 36, the thermal energy is delivered continuously during a build process of the three dimensional object on the build zone.

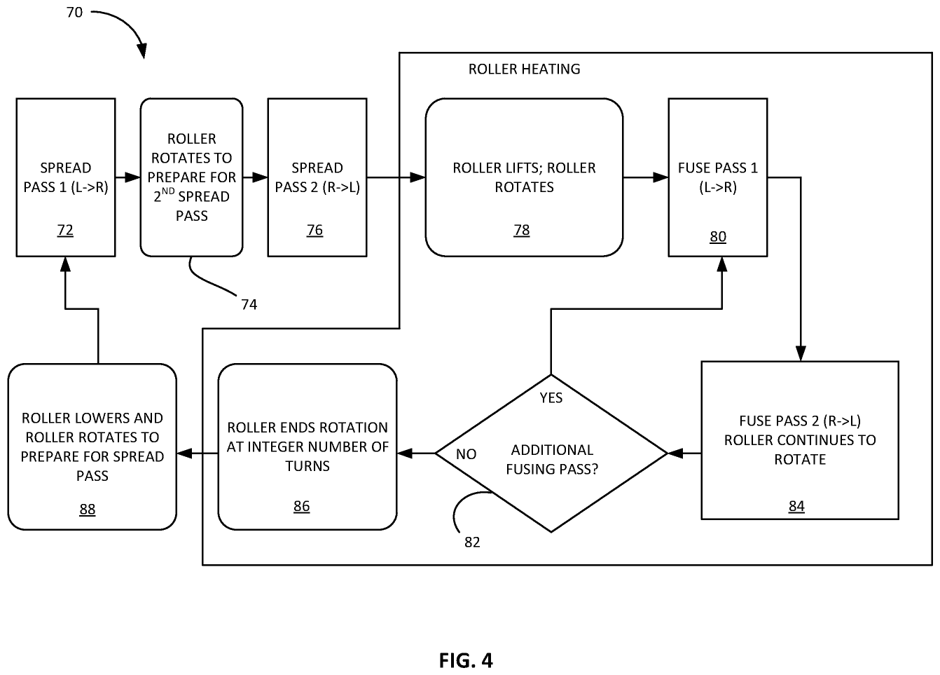

FIG. 3 is a flow chart of another example method 40 of operating a fusing apparatus of an additive manufacturing machine in accordance with aspects of the present disclosure. At 42, a radiant thermic energy is produced with a thermic energy source in a build chamber. The radiant thermal energy is segregated into a first emission spectrum and a second emission spectrum. At 44, the thermic energy source is translated bi-directionally in a plane above a build zone in the build chamber. At 46, translating the thermic energy source delivers a first phase of energy with the first emission spectrum to raise a thermal level of a build material and a fusing agent contained on the build zone above a melt temperature. At 48, a second phase of energy is delivered with the second emission spectrum to maintain the melt temperature. At 50, the build material and the fusing agent contained on the build zone are convectively cooled. At 52, the maintained radiant thermic energy production maintains a warming temperature that is less than the melt temperature within the build chamber during a build process of the three dimensional object.

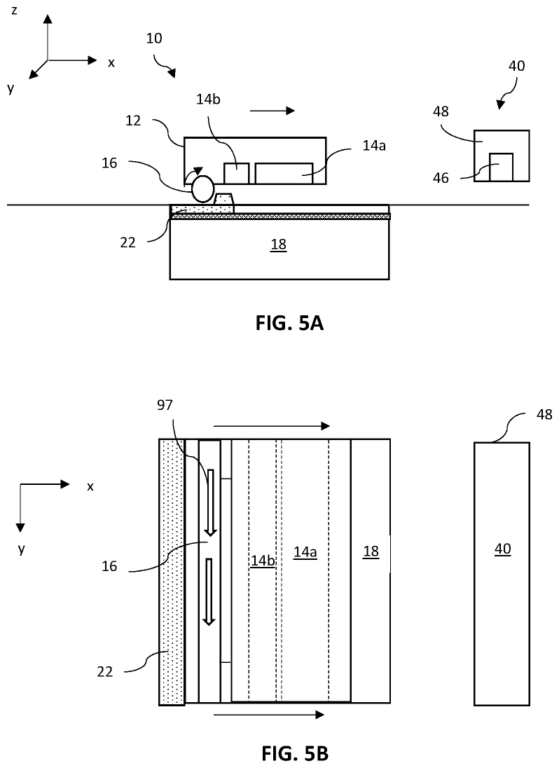

FIG. 4 illustrates one example of additive manufacturing machine 100 including fusing system 10. In addition to fusing system, or assembly, 10, additive manufacturing machine 100 includes a dispensing assembly 60 movable over a build chamber 58. Fusing system 10 and dispensing assembly 60 are movable along the x-axis over build chamber 58. Dispensing assembly 60 includes a printhead 62 (or other suitable liquid dispensing assemblies) mounted to a dispensing carriage 64 to selectively dispense fusing agent 22 and other liquid agents, if used. Build chamber 58 can contain build material 20 and fusing agent 22 as layers are formed. Build chamber 58 can be any suitable structure to support or contain build material 20 in build zone 18 for fusing, including underlying layers of build material 20 and in-process slice and other object structures. For a first layer of build material 20, for example, build chamber 58 can include a surface of a platform that can be moved vertically along the y-axis to accommodate the layering process. For succeeding layers of build material 20, build zone 18 can be formed on an underlying build structure within build chamber 58 including unfused and fused build material forming an object slice. Controller 16 can control energy levels, as discussed further below. Controller 16 can also control other functions and operations of additive manufacturing machine 100.

Thermic energy is continuously emitted from thermic source 14 during the entire build process, or build cycle, of three dimensional objects for compliance with Flicker regulations that regulate for surges in power usage. Energy levels of lamps of thermic source 14 can be individually modulated, adjusted, and tuned during the build process to achieve target powder and part temperatures. Alternatively, energy levels of lamps can be modulated, adjusted, and tuned together as in group(s) or by source type during the build process to achieve target powder and part temperatures. For example, warming source 24 and fusing source 26 can be independently and separately adjusted to emit independently modulated emission spectrums. In one example, power to warming source 24 can be adjusted through a control loop that uses thermal feedback from an infrared camera 70 and controller 16, such as a proportional-integral derivative (PID) controller. For example, an energy level of warming source 24 can be modulated based on temperature feedback a non-contact IR sensor using PID controller 16 to maintain a build material temperature at a targeted set point. In one example, energy level of fusing source 26 is modulated based on a predetermined power modulation. In another example, energy level of fusing source 26 is modulated based on thermal feedback of fused build material temperatures using a non-contact IR camera and PID controller. In one example, a pulse width modulation (PWM) varies between 69% and 78% over the four pass fussing cycles.

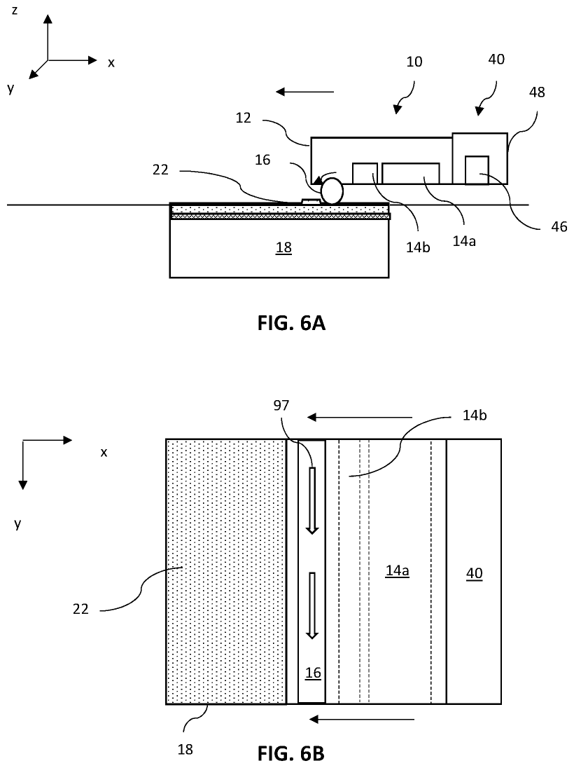

FIGS. 5A-8B are side and top schematic views illustrating an example sequence of a four pass fusing cycle using a fusing system of an additive manufacturing machine. Each pass includes multiple operations that can occur simultaneously during the respective pass. Fusing system 10 and dispensing assembly 60 move bi-directionally over build zone 18 within build chamber 58 along the same line of motion so that carriages 12, 64 can follow each other across build zone 18. A dual carriage fusing system in which carriages 12, 64 move along the same line of motion helps enable faster slew speeds and overlapping functions in each pass. In accordance with one example, direction of movement of the passes, is indicated by arrows in FIGS. 5A-8B. Carriages 12, 64 of fusing system 10 and dispensing assembly 60 move completely and entirely across build zone 18 and can be positioned on either side of build zone 18. In general, a roller 72 can be included on fuser carriage 12 to spread build material 20 to form layers over build zone 18. Dispenser carriage 64 carries the agent dispenser 62 to dispense fusing agent 22 on to each layer of build material 20. Thermic source 14 carried by carriage 12 heats and irradiates layered build material 20 and fusing agent 22.

With respect to thermic source 14 of fusing system 10, thermic source 14 can include any suitable number and type of thermic sources to heat and irradiate build material. Thermic source 14 including lower color temperature warming lamps and higher color temperature fusing lamps can provide control for heating and fusing of build material. Thermic source 14 illustrated in FIGS. 5A-8B include warming and fusing sources 24, 26. Fusing source 26 can be of higher color temperature to sufficiently heat fusing agent 22 and build material 20 to selectively fuse build the build material 20. Warming source 24 can be of lower color temperature to selectively heat the build material 20 without causing fuse build. In one example, fusing source 26 has a 2750 degree Kelvin color temperature. Fusing source 26 can include a series of thermal lamps each being longitudinally arranged in parallel with major axes disposed along the y-axis. In one example, warming source 24 has an 1800 degree Kelvin color temperature. Other color temperatures can also be suitable. A single or multiple warming and fusing sources 24, 26 can be included. Fusing lamp 24 is to irradiate build material 20 with fusing energy.

With reference to FIGS. 5A and 5B, in a first pass of the example sequence, as fuser carriage 12 begins at left of build zone 18 and moves across build zone 18 toward right side of build zone 18. Warming lamp 24 is powered on to heat the underlying layer/slice in front of roller 72 as roller 16 passed across build zone 18 to form a first, or next, layer of build material 20. Roller 72 is positioned to contact build material 20 during the first spreading pass. Thermic energy from warming source 24 is reflected from previous layers of build material 20 to uniformly heat build zone. After first pass has been completed, fuser carriage 12 is positioned to right side of build zone 18 and prepares for a second spreading pass.

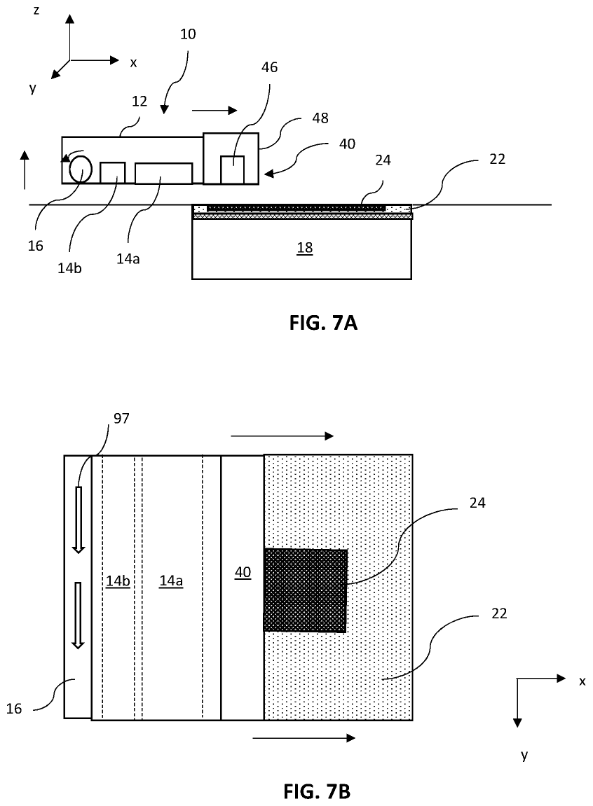

Second pass is illustrated in FIGS. 6A and 6B. In second pass, as fuser carriage 12 moves back over build zone 18 from the right to the left, warming source 24 is on to heat the new layer of build material 20 in advance of dispenser carriage 64, which follows fuser carriage 12 over build zone 18 to dispense fusing and/or detailing agents on to the heated build material 20 in a pattern based on a next object slice. Roller 72 can complete spreading build material 20 that may not be completely spread during first pass, in advance of warming lamp 24 and dispenser carriage 64.

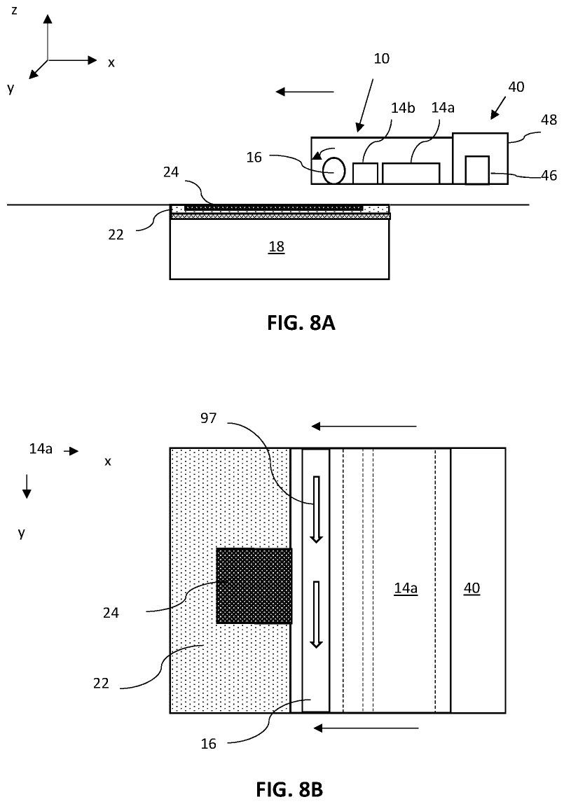

Third pass is illustrated in FIGS. 7A and 7B. Third pass is a fusing pass. In third pass, dispenser carriage 64 moves back over build zone 18, from left to right, to dispense fusing and/or detailing agents 22 on to build material 20, followed by fuser carriage 12 with fusing source 26 on to expose patterned build material to fusing energy.

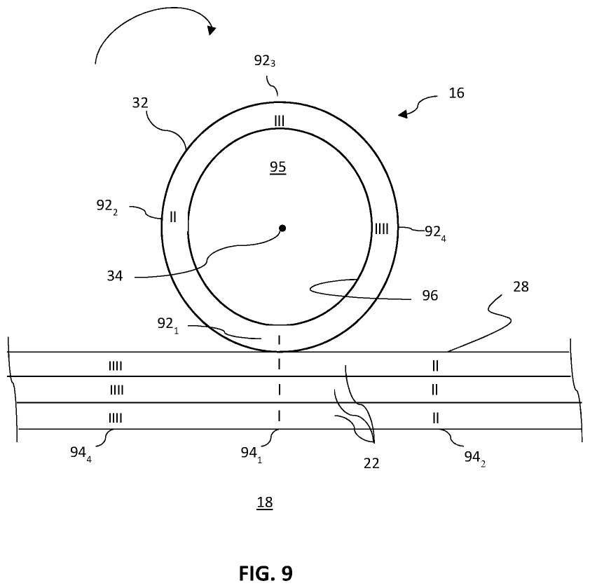

In fourth pass, as illustrated in FIGS. 8A and 8B, as fuser carriage 12 moves back over build zone 18, from right to left, and fusing source 26 is on to expose patterned build material to fusing energy. The four pass process may be repeated for successive layers of build material as the object is manufactured layer by layer and slice by slice. The build cycle is complete when all layers of the build material for the three dimensional object have been completed.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A fusing apparatus for an additive manufacturing machine, comprising:
an enclosure movable in an x-direction across a build zone, the build zone to contain a build material and a fusing agent;
a thermic source housed in the enclosure, the thermic source to direct thermic energy toward the build zone, the thermic source including a warming source to emit a first emission spectrum and a fusing source to emit a second emission spectrum; and
a control to continuously deliver levels of the thermal energy produced by the thermic source during a build cycle.

2. The fusing apparatus of claim 1, wherein the thermic source is to continuously modulate thermic energy during the build cycle.

3. The fusing apparatus of claim 2, wherein the fusing source is adjustable independent of the warming source during the build cycle.

4. The fusing apparatus of claim 1, wherein the warming source has a controlled pulse width modulation over the build cycle.

5. The fusing apparatus of claim 1, wherein the control includes an infrared camera and a proportional integral derivative controller.

6. The fusing apparatus of claim 1, wherein the fusing source includes at least two lamps.

7. The fusing apparatus of claim 1, wherein the first emission spectrum has a lower energy level emission than the second emission spectrum.

8. A method of operating a fusing system of an additive manufacturing machine to form a three dimensional object, comprising:
producing a thermal energy with a thermic source, the thermal energy having a segregated emission spectrum including a first emission spectrum and a second emission spectrum, the first and second emission spectrums each oriented to emit longitudinally along a y-axis;
translating the thermic source along an x-axis over a build zone; and
delivering the thermal energy continuously during a build process of the three dimensional object on the build zone.

9. The method of claim 8, comprising:
heating a build material contained on the build zone to a first temperature with the first emission spectrum; and
heating the build material and a fusing agent contained on the build zone to a second temperature with the second emission spectrum, wherein the second temperature is greater than the first temperature.

10. The method of claim 8, comprising:
modulating energy levels of the continuously delivered thermal energy during the build process.

11. The method of claim 8, comprising:
controlling the thermic source to deliver modulated levels of the thermal energy.

12. A method of operating a fusing system of an additive manufacturing machine to form a three dimensional object, comprising:
producing a radiant thermic energy with a thermic energy source in a build chamber, the radiant thermal energy being segregated into a first emission spectrum and a second emission spectrum;
translating the thermic energy source bi-directionally in a plane above a build zone in the build chamber to:
deliver a first phase of energy with the first emission spectrum to raise a thermal level of a build material and a fusing agent contained on the build zone above a melt temperature;
deliver a second phase of energy with the second emission spectrum to maintain the melt temperature;
convectively cooling the build material and the fusing agent contained on the build zone; and
maintaining the radiant thermic energy production to maintain a warming temperature that is less than the melt temperature within the build chamber during a build process of the three dimensional object.

13. The method of claim 12, comprising:
modulating energy levels of a continuously delivered thermal energy during the build process.

14. The method of claim 12, comprising:
repeatedly translating the thermic energy source in the plane to alternately first-second phases of energy and then second-first phases of energy.

15. The method of claim 12, wherein the first emission spectrum is adjustable independent of the second emission spectrum during the build process.
